(19) United States
(12) Patent Application Publication
(10) Pub. No.: US 2006/0028397 A1
(43) Pub. Date: Feb. 9, 2006

(54) Local area alert system using computer networks

(76) Inventor: Thomas O'Rourke, Seattle, WA (US)

Correspondence Address: GRAYBEAL, JACKSON, HALEY LLP, 155 - 108TH AVENUE NE, SUITE 350, BELLEVUE, WA, 98004-5901, US

(21) Appl. No.: 11/197,042

(22) Filed: Aug. 3, 2005

Related U.S. Application Data
(60) Provisional application No. 60/598,691, filed on Aug. 3, 2004.

(51) Int. Cl. G09G 5/00

(52) U.S. Cl. 345/2.1

(57) ABSTRACT

A system that uses computer driven visual displays in area-defined public places to communicate public alerts to people in those places using large publicly viewable computer driven visual displays and/or computer driven visual displays in the form of hand held mobile telephones, personal digital assistants, and laptop computers. All of these displays can be connected via computer networks, using wireless networks for the mobile devices. With the invented system, public alert messages that are relevant to a locality are distributed via computer networks to computer driven image displays within that locality. They are displayed on all displays, all at once.

### BACKGROUND

People who live and work together have used public alert systems for millennia. Early systems were based on the sound of the human voice or a drum, horn, or bell. In the 19^{th} and 20^{th} centuries, the systems evolved to mechanical sirens, electronic sirens, and loud speakers connected by electrical wires carrying analog sound signals.

### SUMMARY OF THE INVENTION

In one embodiment, the invention is a system that uses computer driven visual displays in area-defined public places to communicate public alerts to people in those places. Publicly viewable computer driven visual displays first became ubiquitous in airports. They were then added to train and bus stations. Such displays are now being setup in other public places as information kiosks. Also, members of the public are now carrying computer driven visual displays in the form of mobile telephones, personal digital assistants, and laptop computers. All of these displays can be connected via computer networks, using wireless networks for the mobile devices. With the invented system, public alert messages that are relevant to a locality are distributed via computer networks to computer driven image displays within that locality. They are displayed on all displays, all at once.

For example, in an airport, computer driven displays show information about departures and arrivals of airplanes. With local area networking technology, all of the computers that drive the displays can be networked and their network addresses can be maintained in a list of computers driven displays located within the relevant locality, in this case, the airport or a portion of the airport. When there is a public emergency in the relevant portion of the airport, the computer that implements the invented system can distribute to the appropriate computers a command to display alert information.

The alert information content can be sent with the command or the command can provide a pointer to alert information content available at another location on the network or a connected computer network. A portion of the information can be specific to the particular destination computer that controls a particular display, specific information such as an arrow indicating a direction of an emergency exit or a direction that members of the public should proceed from the exact location of that visual display.

As another example, personal computer driven visual displays with wireless networking capabilities, such as mobile telephones and personal digital assistants, can be programmed to automatically receive alert information when their device is connected to the system. Once the network address of the wireless device is registered with the system, the device can receive emergency alerts from the system and then automatically display them.

For another example, information display screens may be installed in retail stores or shopping malls. Like the airport example, emergency information alerts can be sent to displays in the entire mall, a portion of the mall, a single retail store, or a portion of a store. Like for airports, the alerts may also be distributed to networked personal mobile computing devices.

### BRIEF DESCRIPTION OF THE FIGURES

FIG. 1 shows the relationships between the server system, its sources of information, and its possible displays.

FIG. 2 shows the hierarchy in “layers” of information displayed on the screens.

### DETAILED DESCRIPTION

The features of the present invention which are believed to be novel are set forth with particularity in the appended claims. Aspects of the invention may best be understood by making reference to the following description taken in conjunction with the accompanying drawings.

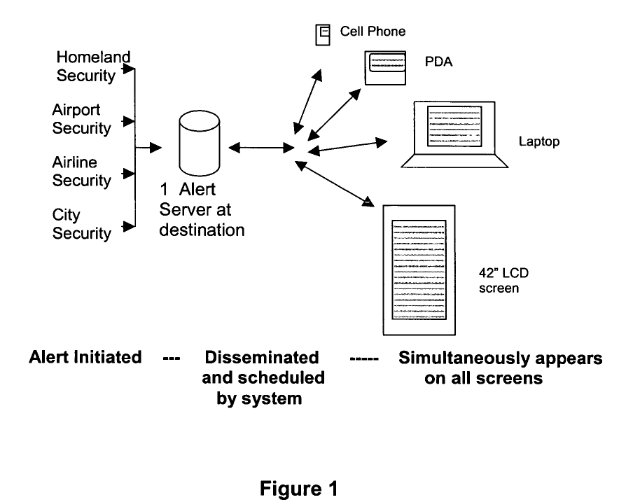

As shown in FIG. 1, the system includes an alert server computer 1, coupled to a wide area computer network for receiving alert input information and coupled to a local computer network for disseminating alert messages to computer displays within at least one local area. The wide area network and the local area network may be a single network which serves both functions or they may be separate networks.

As shown in FIG. 1, the system allows for several sources of alert notification information. Each person who is allowed via an encrypted security password to enter information logs onto an input module (modification tool) of the alert server 1 and may then initiate an alert on the system. As shown in FIG. 1, the alert is disseminated by the alert server out to all alert system screens, regardless of whether they are large display screens, or personal device screens.

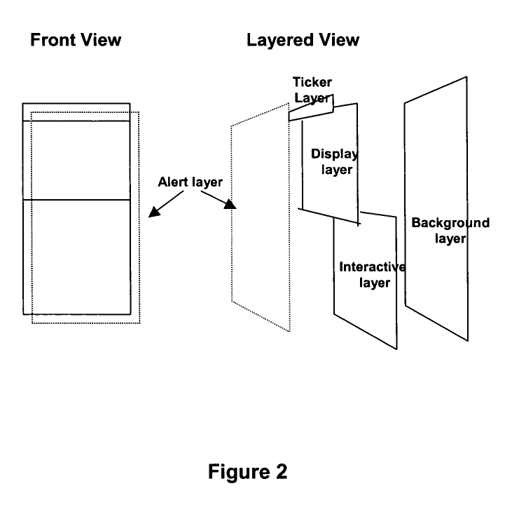

As an example of how the system is used, a person will be in a particular location with one of the system screens displaying the alert message “channel” supplied by the alert server. In the case of an airport, people will be standing by a 43″ LCD monitor that is showing information about the city being serviced by that particular screen. An alert is issued by an approved source, through security measures, with a designation of local areas that should receive the alert message. A start time and an end time for the alert is given to the system, then each one of the screens designated to receive that particular message, displays the message all at the same time. As shown in FIG. 2, the system places a separate, overriding layer of display over the display windows making up the interface, and displays alert message layer over everything else until the alert parameters provided by the alert source have been met, such as instructions to show the alert for only 2 hours.

Personal display devices such as PDA's, cell phones, Blackberry's, etc., will also display the same overriding information while the user has their device set to the “channel” for that particular local area. In an airport, each gate would typically be designated as a separate local area so that a person planning to board a plane at that gate can constantly monitor the latest information for that gate, such as the times that boarding will begin and end. Personal devices access the alert network system through a web site and interface. Someone at the airport, for example, will log onto a specific local information web site where they will be asked to select a gate “channel”. When they choose their gate “channel”, the same information that is displayed at the gate on the large LCD screen, is displayed on the computer or Personal Digital Device screen, including any alert messages that are displayed while the person is logged onto the local information web site.

The alert system can be used to communicate Homeland Security messages, Amber Alerts, Concourse-clearing security breach alerts, and non-emergency messages to the hard of hearing.

In one embodiment, computer program code for the alert communication system for delivering specific information to specific locations, is a Linux based windowing system of hierarchical “windows” that exist in relation to each other on a screen as shown in FIG. 2. Each set of windows is given properties to display certain bits of information following a number of class based rules. These rules are comprised of play-lists of certain elements and certain frequency and system-clock-based timing. They are presented in layers upon the screen, some with priority over others, some in front of others, some behind, as shown in FIG. 2.

The alert layer of the system is a full screen, always in the top most position, and always hidden until given a multi-layered set of commands to have it appear over all other layers. The alert layer acts independently from the other layers in that it is hidden until a command is entered to the system that overrides all other layers and remains until clocked out.

The alert layer is fed information from the alert server. The alert server receives the information via a modification tool user interface and is given form through a CSS style sheet formatting tool within the alert server's windowing system.

In an alternative embodiment using Bluetooth or 802.11 or cellular telephone wireless data protocols (e.g. GPRS), as a user walks through the locality, such as an airport, the local antenna with which the person's device communicates changes from one antenna to another. The specific information that the device receives with the emergency alert can change as a function of which antenna the device is then communicating with so that people in one part of the locality can be given one set of instructions and people in another part of the locality can be given another set of instructions. The alert server obtains an access point identifier to indicate the antenna used for each communicating mobile device. Unless the user has selected a particular local area that the user wants information about, such as a particular gate in an airport, the system can determine which messages to send based on the access point identifier and, for example, send the same alert information as for the nearest gate.

In a further improvement to this alternative embodiment, each person with a handheld web browser device who frequents public places with the invented alert system can download into their device a program that periodically checks for access point antennas that are part of an alert system. When one is found, the program causes the handheld web browser device to register itself with the local alert server to receive local area alerts. This occurs in the background, with no information displayed to the user, until there is a local alert message to be displayed. The content of any alert message that is displayed, and whether a message is displayed, is determined by the identity of the antenna to which the device is connected, as described above.

Because many varying and different embodiments may be made within the scope of the inventive concept herein taught, including equivalent structures or designs hereafter thought of, and because many modifications may be made in the embodiments herein detailed, the details herein are to be interpreted as illustrative and not in a limiting sense. Rather, the invention is defined by the following claims.

1. A local area alert display system, comprising:
a. an alert server computer, coupled to a wide area computer network for receiving alert input information and coupled to a local computer network for disseminating alert messages to computer displays within at least one local area;
b. a plurality of computers, each with a display screen viewable in at least one local area public place, each coupled to the local computer network, each programmed to receive local area alert messages directed by the alert server to a network address for the computer and display the alert message superior to other information received by the computer for display;
c. the alert server including a user interface component with a security log-on feature for receiving alert information, a specification of a local area where the alert information should be displayed, and a time that the alert information should be displayed;
d. the alert server also including a broadcast component that sends the received alert information to computers with display screens within the specified local area for display at the specified time.

2. A wireless local area alert display system, comprising:
a. an alert server computer, coupled to a wide area computer network for receiving alert input information and coupled to a local wireless computer network for disseminating alert messages to computer displays in wireless handheld computing devices within at least one local area;
b. a plurality of wireless antennas, each coupled to the local computer network, each programmed to receive local area alert messages directed by the alert server to a network address for the antenna and broadcast the alert message to nearby wireless handheld computing devices for display;
c. the alert server including a user interface component with a security log-on feature for receiving alert information, a specification of a local area where the alert information should be displayed, and a time that the alert information should be displayed;
d. the alert server also including a broadcast component that sends the received alert information to antennas wirelessly linked to handheld computers with display screens within the specified local area for display at the specified time.
